(19) United States
(12) Patent Application Publication
(10) Pub. No.: US 2016/0110951 A1
(43) Pub. Date: Apr. 21, 2016

(54) System and Method for Synchronising Electronic Gaming Machines

(71) Applicant: Ainsworth Game Technology Limited, Newington (AU)

(72) Inventors: Saar Caspi, Vaucluse (AU); Scott Paul Shelley, Heathcote (AU)

(21) Appl. No.: 14/882,439

(22) Filed: Oct. 13, 2015

(30) Foreign Application Priority Data
Oct. 17, 2014 (AU) 2014904147

(51) Int. Cl. G07F 17/32

(52) U.S. Cl. CPC G07F 17/3216; G07F 17/3223; G07F 17/3267; G07F 17/3258

(57) ABSTRACT

The present invention provides a system for synchronising a plurality of electronic gaming machines in electronic communication with each other. Each electronic gaming machine has a lighting device for displaying a light presentation on the electronic gaming machine and a lighting controller in electronic communication with the lighting device for controlling the display of the light presentation by the lighting device. The lighting controllers of the electronic gaming machines are in electronic communication with each other. A master lighting controller for controlling the lighting controllers transmits one or more signals to the lighting controllers so that the lighting devices of the electronic gaming machines (1) are synchronised to display the same light presentation simultaneously. A method is also provided.

### BACKGROUND

The invention relates to a system and method for synchronising a plurality of electronic gaming machines and in particular a system and method for synchronising the light presentation of a plurality of electronic gaming machines. The invention has been developed primarily for use as system and method for a plurality of electronic gaming machines adjacent each other and will be described hereinafter by reference to this application.

The following discussion of the prior art is intended to present the invention in an appropriate technical context and allow its advantages to be properly appreciated. Unless clearly indicated to the contrary, however, reference to any prior art in this specification should not be construed as an express or implied admission that such art is widely known or forms part of common general knowledge in the field.

A conventional electronic gaming machine typically has an associated light presentation that is produced by one or more lighting devices fitted to or mounted on the machine, generally at height approximate to an average person's line of sight. The light presentation is used to attract potential players, and is associated with the game(s) of chance offered on the electronic gaming machine. Where the electronic gaming machines offer the same game or games of the same type (i.e. having the same game mechanics but differ thematically or having similar game mechanics under the same theme), they are frequently located together in groups or banks of electronic gaming machines in casinos and other gaming venues. However, it is difficult to attract potential players to the electronic gaming machines amidst the light presentations displayed on other electronic gaming machines in the gaming venue, as well as the tendency for the grouped electronic gaming machines to display their respective light presentations independently of each other.

It is an object of the invention to overcome or substantially ameliorate one or more of the disadvantages of prior art, or at least to provide a useful alternative. It is an object of the invention in at least one embodiment to provide a system and method for synchronising electronic gaming machines that encourages interest playing one of the synchronised electronic gaming machines.

### SUMMARY

According to a first aspect of the invention, there is provided a system for synchronising a plurality of electronic gaming machines, comprising:

a plurality of electronic gaming machines in electronic communication with each other, each said electronic gaming machine comprising:
a display for displaying a game;
an electronic game controller in electronic communication with said display for controlling the display of game symbols on the display;
a lighting device for displaying a light presentation on said electronic gaming machine; and
a lighting controller in electronic communication with said lighting device for controlling the display of said light presentation by said lighting device;

wherein said lighting controllers of said electronic gaming machines are in electronic communication with each other;

one of said lighting controllers is designated as a master lighting controller for controlling the other lighting controllers; and

said master lighting controller transmits one or more signals to said lighting controllers so that said lighting devices of said electronic gaming machines are synchronised to display the same light presentation simultaneously.

Preferably, in response to a game event on a first electronic gaming machine, said lighting controller of said first electronic gaming machine transmits a first signal to said master lighting controller reporting said game event and said master lighting controller transmits a second signal to each of said lighting controllers to change the light presentation displayed by said lighting device on each of said electronic gaming machines simultaneously to another light presentation. More preferably, said lighting controller of said first electronic gaming machine broadcasts said first signal to each of said lighting controllers.

Preferably, said lighting controllers are in wireless electronic communication with each other.

Preferably, each said lighting controller comprises a transmitter for transmitting signals and a receiver for receiving signals. More preferably, said transmitter and said receiver comprise a communication module. Alternatively, each said lighting controller comprises a transceiver for transmitting and receiving signals. In one embodiment, said transceiver comprises a radio frequency module.

Preferably, where the designation of said one of lighting controllers as said master lighting controller is removed, another of said lighting controllers is designated as said master lighting controller.

Preferably, in response to said master lighting controller being deactivated, another of said lighting controllers is designated as said master lighting controller.

Preferably, each said electronic gaming machine comprises a housing having said display. More preferably, said housing comprises a body portion. In one embodiment, said lighting device is arranged on said body portion. In another embodiment, said body portion comprises a cabinet.

Preferably, said housing comprises a removable head portion. More preferably, said lighting device is arranged on said removable head portion. In one embodiment, said removable head portion comprises a topper.

Preferably, said housing comprises a foot portion. More preferably, said lighting device is arranged on said foot portion.

Preferably, each said electronic gaming machine comprises an input device for receiving commands from a player to operate said electronic gaming machine and initiate play of said game on said display, said input device being in electronic communication with said electronic game controller. More preferably, said housing comprises said input device. In one embodiment, said input device comprises one or more buttons on said housing, said buttons being in electronic communication with said electronic game controller to transmit player commands to said electronic game controller. In some embodiments, said buttons are arranged on a console of said housing. Alternatively or additionally, said input device comprises a touch sensitive surface on said display for receiving player commands, said touch sensitive surface being in electronic communication with said electronic game controller to transmit player commands to said electronic game controller.

Where said input device comprises buttons on said housing, it is preferred that said lighting device is arranged adjacent to said buttons. In some embodiments, said lighting device substantially surrounds said buttons. In other embodiments, where said buttons are arranged on said console, said lighting device is arranged on said console.

Preferably, said electronic gaming machine comprises a value transfer mechanism for paying said prizes to said player using value in an amount equal to an awarded prize. More preferably, said housing comprises said value transfer mechanism. In one embodiment, said value transfer mechanism also receives value from said player to initiate said bet. In another embodiment, said value transfer mechanism comprises one or more vending slots for paying and/or receiving value. In other embodiments, said value transfer mechanism comprises a value input/value output device. In further embodiments, said value transfer mechanism comprises a coin slot or acceptor, a paper currency acceptor, a ticket reader and/or printer or a card reader and/or writer.

Throughout the specification and unless explicitly stated otherwise, the term “value” means credits, gaming tokens, coins, paper, currency, tickets, vouchers, credit cards, debit cards, smart cards, memory devices capable of storing value and any other object representative of value.

Preferably, said lighting device is arranged adjacent to value transfer mechanism. In some embodiments, said lighting device substantially surrounds said value transfer mechanism.

Preferably, said lighting controller controls a lighting system, said lighting system comprising a plurality of said lighting devices.

Preferably, said lighting device comprises one or more light emitting diodes (LEDs). In other embodiments, said lighting device comprises an incandescent lighting device, cold-cathode lighting device, electroluminescent lighting device, fluorescent lighting device or laser diode.

Preferably, said game event comprises a prize award event. More preferably, said prize award event comprises an event that results in the award of a prize on said first electronic gaming machine. In some embodiments, said prize award event comprises one or more of a winning combination of game symbols resulting in the award of said prize, the appearance of a symbol that awards a prize, winning a bonus prize and winning a jackpot prize. Alternatively or additionally, said game event comprises a game enhancing event that enhances said game on said first electronic gaming machine. More preferably, said game enhancing event comprises an event that enhances the game play of said game or confers a game enhancing element upon said player in said game. In some embodiments, said game enhancing event comprises one or more of triggering a feature game, additional free plays or spins of said game, the appearance of symbols that increase the amount of any awarded prizes and the appearance of symbols that increase the probability of a winning combination of symbols appearing in said game.

Preferably, the electronic gaming machine comprises a mobile electronic gaming device. More preferably, said mobile electronic gaming device comprises a handheld electronic device. In one preferred form, said handheld electronic device comprises a handheld electronic gaming device or a smart phone. Alternatively, said electronic gaming machine comprises a computer. More preferably, said computer is connected to a communication network.

According to a second aspect of the invention, there is provided a method for synchronising a plurality of electronic gaming machines, each of said electronic gaming machines having a display for displaying a game of chance; an electronic game controller in electronic communication with said display for controlling the display of game symbols on the display; a lighting device for displaying a light presentation on said electronic gaming machine and a lighting controller in electronic communication with said lighting device for controlling the display of said light presentation by said lighting device, said method comprising:

placing said lighting controllers of each said electronic gaming machine in electronic communication with each other;

designating one of said lighting controllers as a master lighting controller to control the other lighting controllers;

controlling the light presentation displayed by said lighting device on each electronic gaming machine;

transmitting one or more signals from said master lighting controller to said lighting controllers to synchronise said lighting devices of said electronic gaming machines; and

said lighting devices displaying the same light presentation simultaneously.

Preferably, in response to a game event on a first electronic gaming machine, transmitting a first signal from said lighting controller of said first electronic gaming machine to said master lighting controller reporting said game event, transmitting a second signal from said master lighting controller to each of said lighting controllers and changing, in response to said second signal, the light presentation displayed by said lighting device on each of said electronic gaming machines simultaneously to another light presentation. More preferably, said first signal transmitting step comprises broadcasting said first signal from said lighting controller of said first electronic gaming machine to each of said lighting controllers.

Preferably, said placing step comprises placing said lighting controllers in wireless electronic communication with each other. More preferably, said placing step comprises enabling said lighting controllers to transmit and receive signals. In one embodiment, said placing step comprises enabling said lighting controllers to transmit and receive radio frequency signals.

Preferably, said method comprises removing the designation of said one of lighter controllers as said master lighting controller and designating another of said lighting controllers as said master lighting controller.

Preferably, in response to deactivation of said master lighting controller, said method comprises designating another of said lighting controllers as said master lighting controller.

Preferably, said method comprises arranging said lighting device on a housing of said electronic gaming machine, where said housing comprises said display. More preferably, said lighting device is arranged on a removable head portion of said housing. In one embodiment, said lighting device is arranged on a body portion of said housing. In another embodiment, said lighting device is arranged on a foot portion of said housing.

Preferably, said method comprises arranging said lighting device adjacent to an input device of said electronic gaming machine, said input device being in electronic communication with said electronic game controller. In one embodiment, said input device comprises one or more buttons on said housing, and said method comprises arranging said lighting device adjacent to said buttons. In other embodiments, said method comprises arranging said lighting device to substantially surround said buttons. In some embodiments, said buttons are arranged on said console, said method comprises arranging said lighting device on said console.

Preferably, said method comprises arranging said lighting device adjacent to a value transfer mechanism on said housing, said value transfer mechanism for paying said prizes to said player using value in an amount equal to an awarded prize. In some embodiments, said method comprises arranging said lighting device to substantially surround said value transfer mechanism.

The method preferably has the preferred features of the first aspect of the invention stated above, where applicable.

According to a third aspect of the invention, there is provided a computer system comprising a central processing unit configured for communication with a plurality of electronic gaming machines, wherein said computer system is configured to perform the method of the second aspect of the invention.

According to a fourth aspect of the invention, there is provided a computer programme configured to perform the method of the second aspect of the invention.

According to a fifth aspect of the invention, there is provided a non-transitory carrier medium carrying computer executable code that, when executed on a central processing unit configured for communication with a plurality of electronic gaming machines, causes the central processing unit to perform the method of the second aspect of the invention.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

Furthermore, as used herein and unless otherwise specified, the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

### BRIEF DESCRIPTION OF THE DRAWINGS

Preferred embodiments of the invention will now be described, by way of example only, with reference to the accompanying drawings in which:

FIG. 1 is a perspective view of an electronic gaming machine according to one embodiment of the invention;

FIG. 2 is a schematic drawing of an electronic game controller for the electronic gaming machine of FIG. 1;

FIG. 3 depicts a front view of the electronic gaming machine of FIG. 1 illustrating the lighting devices;

FIG. 4 is a schematic drawing illustrating the lighting controller for the electronic gaming machine of FIG. 1;

FIG. 5 is a front view of a plurality of electronic gaming machines of FIG. 3;

FIG. 6 is a front view of a plurality of electronic gaming machines;

FIG. 7 is a front view of the plurality of electronic gaming machines of FIG. 6;

FIG. 8 is a front view of two groups of electronic gaming machines in a single network according to another embodiment of the invention;

FIG. 9 is a front view of the network of FIG. 8; and

FIG. 10 is a schematic drawing showing groups of electronic gaming machines in separate networks;

FIG. 11 is a perspective view of an electronic gaming machine according to yet another embodiment of the invention;

FIG. 12 is a schematic drawing of a control panel for the electronic gaming machine of FIG. 11; and

FIG. 13 is a block diagram of the electronic components of the electronic gaming machine of FIG. 11.

### DETAILED DESCRIPTION OF VARIOUS EMBODIMENTS

The present invention will now be described with reference to the following examples which should be considered in all respects as illustrative and non-restrictive. In addition, the same or corresponding features in embodiments of the invention have been given the same reference numerals in the Figures.

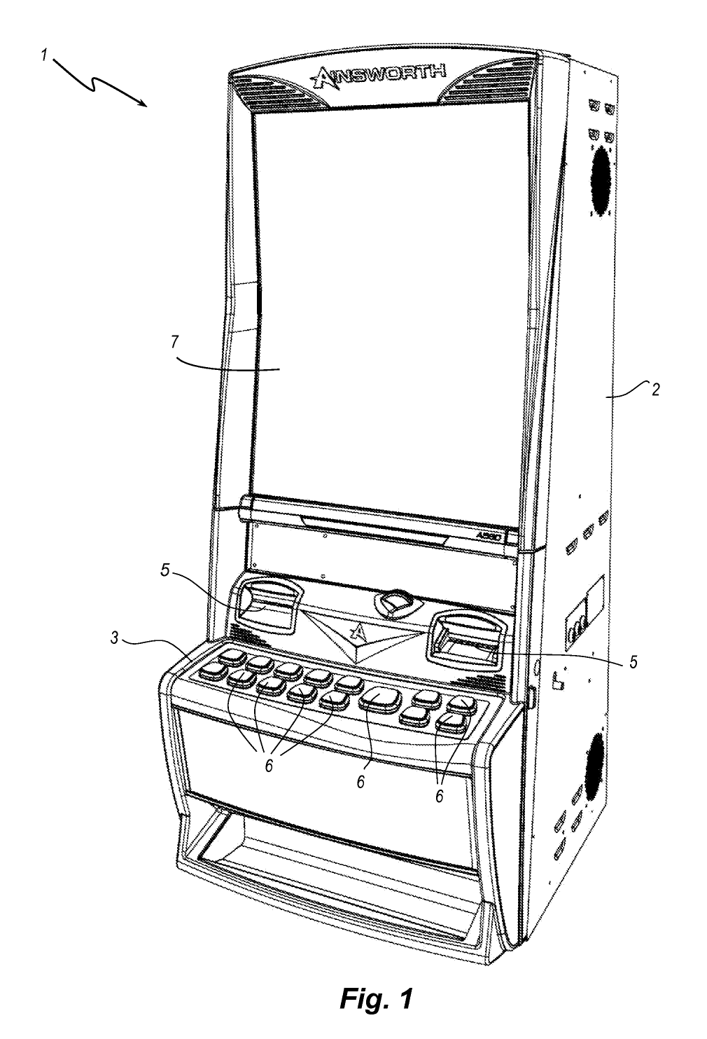

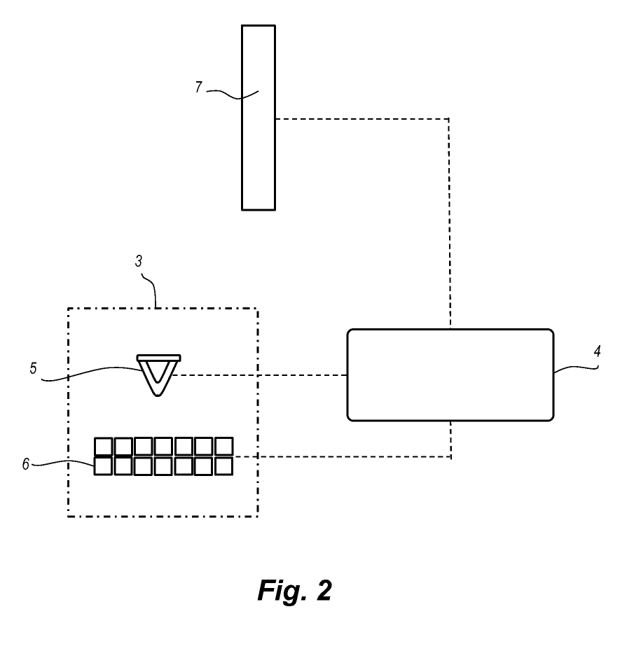

Referring to FIGS. 1 and 2, an electronic gaming machine 1 comprises a housing in the form of a cabinet 2, a console 3 and an internal electronic game controller 4. The console 3 has various input devices including vending slots 5 for receiving monetary bets and a plurality of buttons 6 for actuation by a player. It will be appreciated that in other embodiments the vending slots may be replaced with other types of value input/value output devices, such as a coin acceptor, a paper currency acceptor, a ticket reader and/or printer or a card reader and/or writer.

The vending slots 5 can be configured to receive value, such as cash in the form of banknotes and coins, or credits representing a monetary amount from a memory device, such as but not limited to a memory card, smart card, a radio frequency identification (RFID) device, USB key, magnetic card or other electronic storage device. Typically, the memory device is a credit card, debit card or other card that enables the transfer of monetary credit to the electronic gaming machine 1. Other forms of value include gaming tokens, paper, tickets, vouchers, and any other object representative of value.

The electronic game controller 4 is generally in the form of a central processing unit, such as a computer, and is in electronic communication with a display in the form of a video display screen 7, as well as various input devices on the console 3, as best shown in FIG. 2. Typically, the electronic game controller 4 also comprises a random access memory (RAM) associated with the central processing unit, the RAM being used to store programme instructions and transient data related to the operation of the electronic game controller and hence the electronic gaming machine 1. The RAM contains a body of program instructions for implementing a game on the electronic gaming machine 1, as discussed in more detail below. The central processing unit or processor may also be operatively associated with a further storage device, such as a hard disk drive, which is used for long-term storage of program components and data relating to the electronic game controller 4 and/or the electronic gaming machine 1, including a database for game performance data, as well as information gathered from users. It is also appreciated that a person skilled in the art would readily understand the location and use of the electronic game controller 4 in the electronic gaming machine 1.

The electronic game controller 4 will transmit and receive signals to and from each of the input devices and the display 7, usually via wired connections but can include wireless modes of electronic communication, such as WLAN. In the case of the vending slots 5 (or with any other type of value transfer mechanism), there may be an intermediate credit verification device that examines and verifies the cash or credits received by the vending slots. Once the value (such as cash or credits) have been verified by the credit verification device, a signal is sent to the electronic game controller 4, which then determines whether the minimum bet level has been reached. If so, the electronic game controller 4 will permits play of the game on the electronic gaming machine 1. If not, the electronic game controller 4 will send a signal to the display 7 to show a message requesting further value to be added to the electronic gaming machine.

The electronic game controller 4 is programmed to provide a game in the form of a base game (not shown) and optionally a feature game 9 (not shown) on the electronic gaming machine 1 for play by a player. The base game typically has game symbols arranged into an array in the form of five columns or “reels” that are displayed in a lower area 7a of the display 7, as best shown in FIG. 1. The reels give the visual appearance of rotating, typically by having the game symbols move in a downward linear path along the length of each reel. While the array is arranged with five reels and three rows as per the industry standard, it will be appreciated by one skilled in the art that other types of arrays could be used, such as 3×3, 4×3, 5×5, 4×4, etc, including arrays having an irregular number of rows and/or columns. For example, the array can have an unequal number of rows and/or columns, where some columns have less or more rows than other columns or where some rows have less or more columns than other rows. A more specific example would be an array having three columns with only two rows and two columns with three rows. The electronic game controller 4 will transmit signals to the display screen 7 to cause the base game and feature game to be played on the display screen 7, including showing the game symbols, array, reels and other visible elements of the base game and feature game, as discussed in more detail below.

The array of the base game defines game positions or symbol positions, in which the game symbols appear. The game or symbol positions are not visually marked by boundary lines and simply provide an area for the game symbols to appear. However, it will be appreciated that in other embodiments, the game or symbol positions are defined by visible boundary lines (to define “squares” or cells) or other markings to define each respective area of the symbol positions.

The array is arranged so that a player can select one or more predetermined “pay lines” defined around the array, which correspond to combinations of the game positions or symbol positions. The pay lines correspond to the lines selected by the player and generally comprise at least one game position or symbol position from each reel. The number of pay lines that can be selected by the player depends on the amount of the monetary bet for playing a game on the array. In the base game, predetermined winning combinations of randomly selected game symbols appearing on the same pay line result in the award of prizes to the player.

The game symbols can include a mixture of picture symbols (such as animal symbols or playing card symbols), word symbols, scatter symbols, substitute symbols and trigger symbols to trigger the feature game. Those skilled in the art will readily understand that a substitute symbol is able to act as any other game symbol, and hence is also known as a “wild card” symbol. Likewise, those skilled in the art will readily understand that a scatter symbol is a symbol that triggers a game event or confers an award without having to appear on a player-selected pay line. A trigger symbol is a symbol that triggers a game event or confers an award, where the trigger symbol may or may not have to appear in combination and may or may not have to appear on the same player-selected pay line. In this embodiment, the game symbols include playing card symbols, item-themed or picture symbols, a substitute symbol and a scatter symbol. The electronic game controller 4 randomly determines the appearance of the game symbols on the array and then sends an appropriate signal to the display screen 7 to cause the display of the game symbols on the array.

The video screen 7 also displays standard game information adjacent the array in a lower screen area 7a. The standard game information includes name of the game, the amount of player credits, the amount of the current bet wagered by the player, the amount of wins by the player, a message area, and a current denomination button indicating the currently selected base bet denomination, the number of pay lines available and the number of player-selected pay line.

In the base game, the player initially makes a bet using vending slots 5 to initiate play of the electronic gaming machine 1 by building up credit to play the base game on the electronic gaming machine. The player can bet or wager monetary amounts equivalent to a particular amount of credits, depending on the bet denomination selected for the base game. For example, the player can bet or wager 50 credits to play 10 pay lines or 200 credits to play 50 pay lines. Also, the player can make any additional side bets or ante-bets to access additional features in the base game, such as increasing the number of winning combinations in the game.

Typically, electronic gaming machines offer a number of preset bet options that the player can make, and these bet options can vary depending on the game or games offered on the electronic gaming machine. For example, a game on an electronic gaming machine may provide bet options of 1 credit, 2 credits, 5 credits and 10 credits per player-selected pay line. In another example, the player may bet 1 credit, 2 credits, 5 credits and 10 credits for a preset group or combination of pay lines 14, such as a group of 5 pay lines, 10 pay lines, 20 pay lines, etc. The electronic gaming machine 1 also offers a variety of bet denominations of 1¢, 2¢, 5¢ and 10¢ for the base game.

The electronic gaming machine also has a default bet denomination, which is usually the bet denomination that was previously used in the preceding play of the base game. For example, if a person had played the base game with a bet denomination of 5¢, then this would be the default bet denomination for the player when he or she commences play of the game. Where the electronic gaming machine has not yet been played or has been started up, the default bet denomination is initially selected by the electronic game controller 4. The default bet denomination can be randomly selected or chosen according to a predetermined order. Typically, the electronic game controller 4 will select the bet denomination with the lowest value that is available for the base game, which would be the 1¢ bet denomination for this embodiment. The player may change the bet denomination at any time in the base game by touching the denomination button before or after the reels 12 have spun.

The electronic game controller 4 then transmits a signal to the display 7 to cause the reels to appear to visibly rotate or “spin” in a linear path, typically in a downward vertical direction, and randomly display the game symbols in each symbol position for each play of the array for the base game. After the reels stop spinning, the electronic game controller 4 determines whether there are any predetermined winning combinations of the game symbols appearing in any player-selected pay lines 14, such as a two of a kind, three of a kind, four of a kind or five of a kind for all the game symbols and other combinations of a “full house”, “straight” or “flush” for the playing card game symbols. It will be appreciated that other winning combinations of game symbols can also be provided. If so, the gaming machine 1 enters a winning game state and awards a prize according to the displayed predetermined winning combination.

The electronic gaming machine may also offer one or more jackpot (or bonus) prizes that can be linked to the base game and/or feature game or be entirely separate to both the base game and feature game. The jackpot prizes can be fixed amounts in one embodiment. In another embodiment, the amounts for the jackpot prizes are variable, depending on the bet initially made by the player to play the base game. Thus, the higher the amount of the bet, the higher the jackpot prize that can be won. In other embodiments, the jackpot prizes comprise progressive jackpots that are typically confined to the electronic gaming machine 1. However, in another embodiment, the progressive jackpot prizes are configured to be part of a wide area or in-house linked progressive jackpot prize. In other words, the progressive jackpot prizes can be awarded on a group of networked gaming machines 1 in a specified area or a group of specified electronic gaming machines that are linked together for jackpot purposes. The jackpot prizes can also be shared with any other games offered on the same electronic gaming machine 1 (as in multi-game gaming machines).

In addition, the electronic game controller 4 randomly determines whether a predetermined trigger event has occurred which triggers the feature game on the electronic gaming machine 1. In one embodiment, the trigger event is the appearance of three scatter symbols anywhere on the reels without having to be on a player-selected pay line. The electronic game controller 4 then causes the feature game to be shown on the lower area 7a of the screen 7.

The feature game uses the same array, reels, game symbols, symbol positions and pay lines as in the base game. In the feature game, a number of free plays or spins of the reels are awarded to the player, with the number of free spins being indicated in a counter (not shown). It will be understood by those skilled in the art that free plays or spins are commonly referred to as “free games”. The feature game may also provides a second array that the electronic game controller 4 causes to be displayed in the upper area 7b of the video display screen 7 above the array. The second array can be in the form of a bonus reel that awards a game enhancing element upon the player via a special symbol. In other embodiments, the feature game uses an array different to the array of the base game.

The electronic game controller 4 then causes any prizes to be paid out for any predetermined winning combinations of game symbols that appear on any player selected pay lines in the reels of the array. This concludes a play or spin of the feature game, unless one of the predetermined combinations of game symbols triggers the award of the game enhancing element. The game enhancing element can be conferred by a special symbol displayed on the reels of the array or the second array/bonus reel where one is provided.

It will be appreciated that a variety of game enhancing elements can be awarded by the special symbols, including:
symbols that award a predetermined number of free plays of said game;
win multiplier symbols that multiply the amount of any win from one of said predetermined winning combinations;
“wild” symbols that cause the display of substitute symbols in randomly selected symbol positions;
bonus symbols that awards a bonus prize, either as a monetary amount or as a bonus credit;
wild multiplier symbols that cause the display of substitute symbols on the array and multiplies the amount of any win from one of said predetermined winning combinations;
bonus wild symbols that cause the display of substitute symbols on the array and awards a bonus prize;
symbols that cause the award of additional free plays of said game;
symbols that cause one or more of said symbol positions to be held static (typically one or more reels) and display substitute symbols on the array;
symbols that cause the same game symbol to be stacked in a group of symbol positions, typically the group being one or more reels;
symbols that cause the display of new game symbols on the array;
“reveal” symbols that cause a game symbol to reveal another game symbol;
“jackpot” symbols that result in the award of a bonus, jackpot or progressive jackpot prize, typically the bonus, jackpot or progressive jackpot prize being awarded upon a certain number of jackpot symbols being accumulated by the player during playing the game; and
“replacement” symbols that cause one or more game symbols to be replaced by other game symbols in the array.

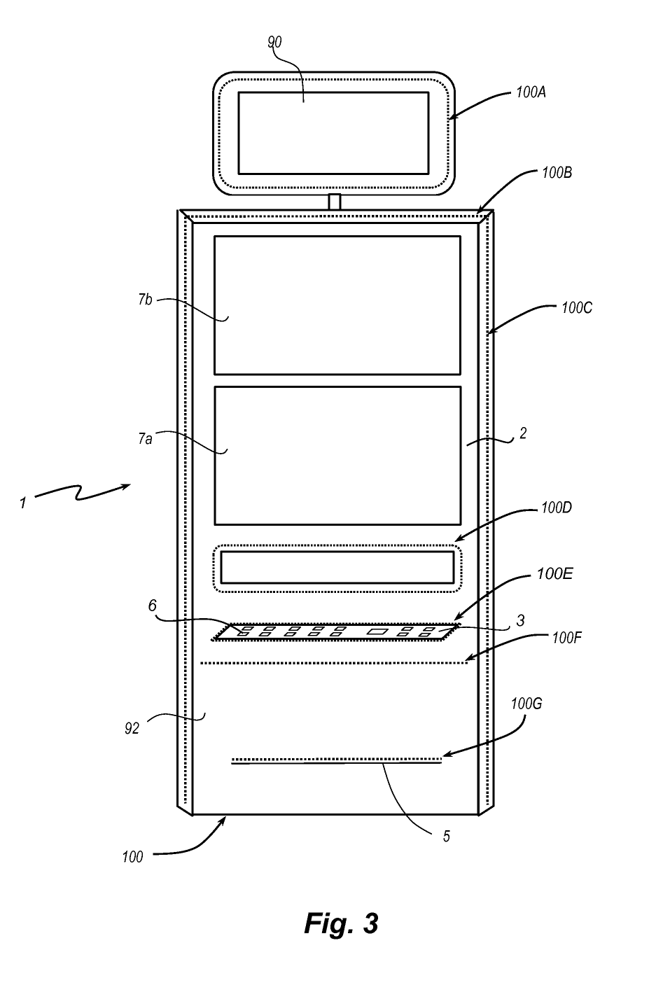

FIG. 3 illustrates the lighting system 100 on another type of electronic gaming machine 1. The electronic gaming machine 1 is not structurally identical to the electronic gaming machine of FIG. 1, but operates in the same way. The main difference is that the electronic gaming machine 1 comprises a removable head portion 90 in the form a “topper”, a body portion in the form of cabinet 2 and a foot or base portion 92. Another difference is that there are two video screens 7a and 7b instead of a single video screen 7.

The electronic gaming machine 1 also has a lighting system 100 that comprises a plurality of lighting devices 100. The lighting devices 100 comprise a topper light 100A, a cabinet top light 1008, cabinet side lights 100C, a player tracking light 100D, a button panel light 100E, a bottom door light 100F and a vending slot light 100G. Where the value transfer mechanism (such as vending slots 5) is located higher up in the cabinet 2, there is generally a foot well that is surrounded the vending slot light 100G. Each of the lighting devices 100A to 100G comprise one or more LEDs that are capable of providing light at various intensities and colour as required.

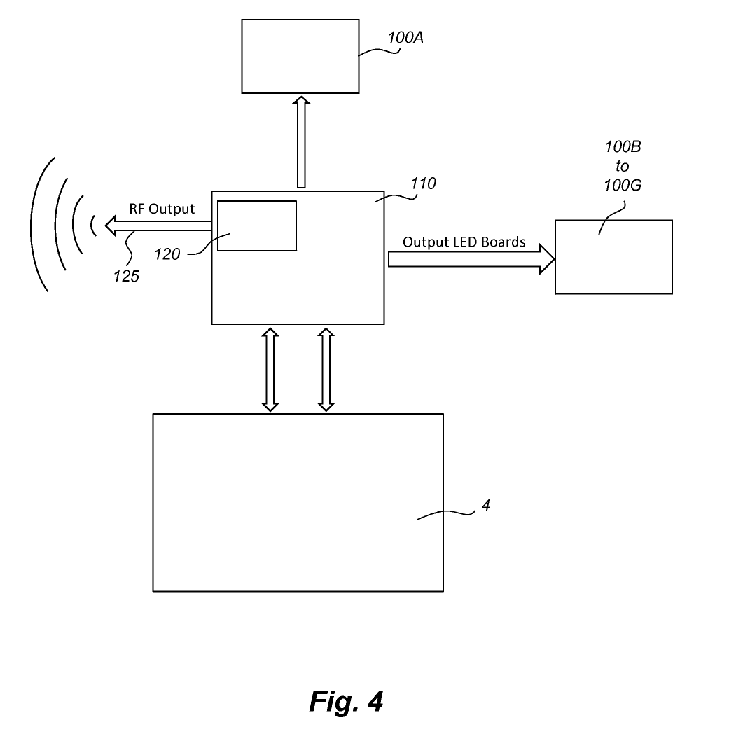

The lighting devices 100A to 100G (and hence the overall lighting system 100) is controlled by a lighting controller 110 that is in electronic communication with the electronic game controller 4 and the individual lighting devices 100A to 100G, as best shown in FIG. 4. The lighting controller 110 transmits signals to each of the lighting devices 100A to 100G in response to a command signal from the electronic game controller 4 to coordinate a light presentation given by the lighting system 100 with various events that occur on the electronic gaming machine 1. For example, a light presentation indicating when a jackpot prize is won during play of the electronic gaming machine 1, the electronic game controller 4 will transmit a signal to the lighting controller 110 to provide a light presentation (such as flashing lights, light patterns, showing lights of different intensities and/or multiple bright colours) and the lighting controller 110 will then send a signal to each lighting device 100A to 110G to create the light presentation. Similarly, where a winning combination of game symbols in the base game appears, resulting in the award of a prize, the electronic game controller 4 will transmit a signal to the lighting controller 110 to provide a different light presentation (such as a continuous light of a single colour) and the lighting controller 110 will then send a signal to each lighting device 100A to 110G to create the light presentation.

A light presentation may also be used where there is no one playing the electronic gaming machine 1, a so-called “idle mode”. In this idle mode, the light presentation may comprise, for example, so-called “chaser lights” where the light devices 100A to 100G will each have portions of the LEDs “light up” sequentially to make it appear that a light is moving around the perimeter of the respective light device. However, other light presentations designed to attract potential players to the electronic gaming machine 1 may be used. It will also be appreciated that some light presentations may not require the use of all the light devices 100A to 100G on the electronic gaming machine 1, and in this case the lighting controller 110 would issue different signals to the lighting devices so that only the required lighting devices operate to give the required light presentation.

The lighting controller 110 also comprises a transceiver in the form of a radio frequency (RF) module 120 to transmit and receive RF signals 125 to and from other lighting controllers 110 of other electronic gaming machines 1, as best shown in FIG. 4. This enables the lighting controllers 110 of the electronic gaming machines 1 to communicate with each other.

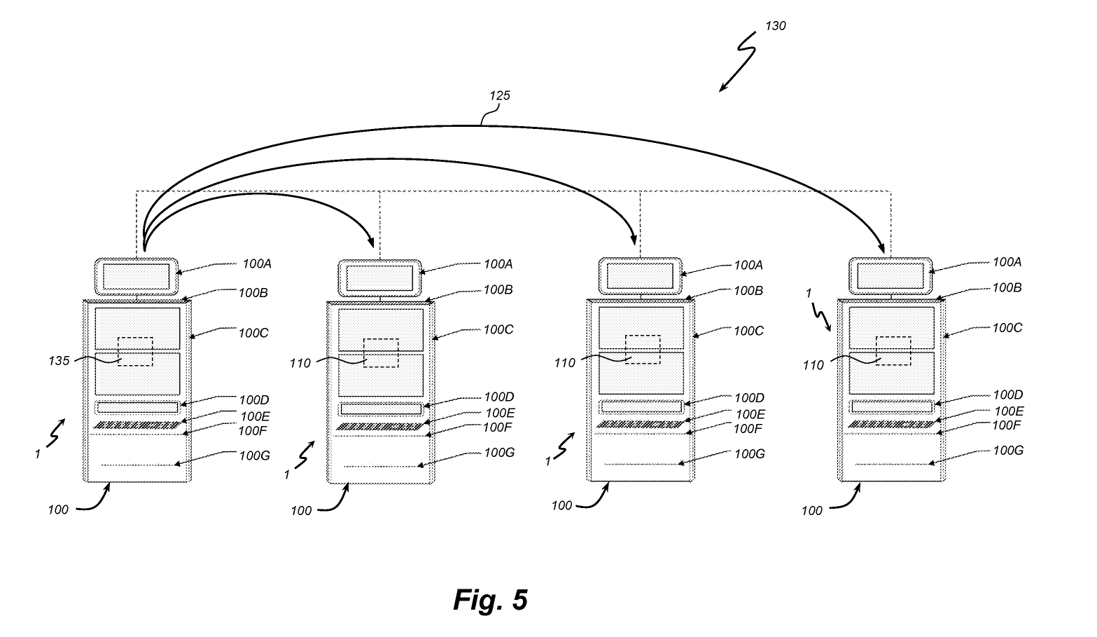

The electronic gaming machines 1 are formed into a group 130, as best shown in FIG. 5 by virtue of their communication with their respective lighting controllers 110. Alternatively or additionally, the electronic gaming machines are also in electronic communication through their respective electronic game controllers 4. The number of electronic gaming machines 1 shown in FIG. 5 is by way of example only, and any number of electronic gaming machines can be formed into a group 130.

Within this group 130, one of the lighting controllers 110 will be designated as a master lighting controller 135, which will control the other lighting controllers 110 in the group. The master lighting controller 135 will send RF signals 125 to the other lighting controllers 110 so that the lighting devices 100A to 100G are synchronised to simultaneously display the same light presentation on each of their respective electronic gaming machines 1. This provides a uniform look and display to the electronic gaming machines 1 and hence increases their attraction to potential players. It also assists in attracting more players where the electronic gaming machines 1 in the same group 130 display the same “winning” light presentation in response to a game or jackpot prize winning event that occurs on one of the electronic gaming machines.

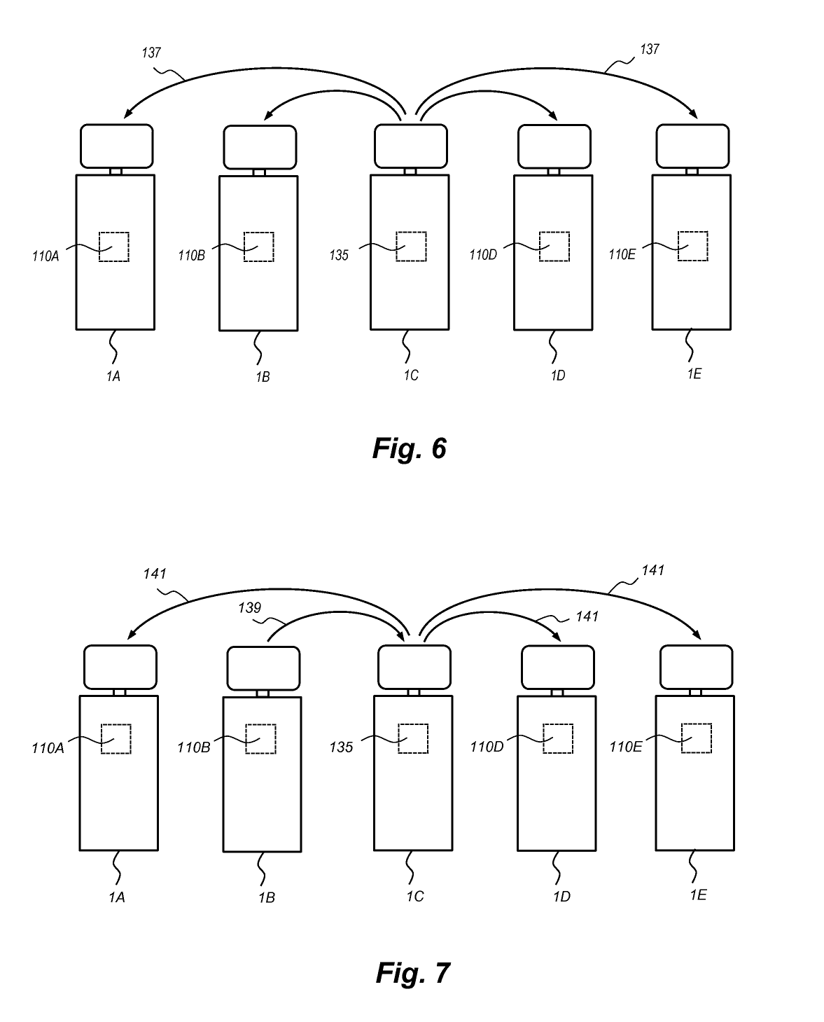

Referring to FIG. 6, a group 130 of five electronic gaming machines 1A to 1E are installed adjacent each other at a gaming venue. At initial installation of the electronic gaming machines 1, one of the lighting controllers 110 is designated as the master lighting controller 135 (being lighting controller 110C of electronic gaming machine 1C) to control the other lighting controllers 110A, 110B, 110D and 110E. The master lighting controller 135 transmits an RF signal 137 to the other lighting controllers 110A, 110B, 110D and 110E to put their respective lighting devices 100A to 100G into idle mode and simultaneously display the light presentation associated with the idle mode. When a player commences play of one of the electronic gaming machines 1, such as electronic gaming machine 1B, the other electronic gaming machines remain in idle mode. As best shown in FIG. 7, when an event occurs on the electronic gaming machine 1B being played, such as a prize being won during play of a base game or feature game, the feature game being triggered, additional free spins being awarded, a game enhancing element being awarded as described above or a jackpot prize being won, the electronic game controller 4 transmits a signal to the lighting controller 110B of that electronic gaming machine 1B, which in turn then transmits an RF signal 139 to the master lighting controller 135 reporting the game event. The master lighting controller 135 then transmits an RF signal 141 to the lighting controllers 110A, 110D and 110E to change the light presentations of their respective lighting systems 100 (and hence their respective lighting devices 100A to 100G) to display the same light presentation simultaneously as the light presentation associated with the game event occurring on the played electronic gaming machine 1B.

When the relevant game event ends, the master lighting controller 135 transmits another RF signal returning the lighting controllers 110A, 110D and 110E (and their respective lighting systems 100) back to the idle mode, while the lighting controller 110B returns the lighting system 100 of the played electronic gaming machine 1B back to the light presentation displayed during game play.

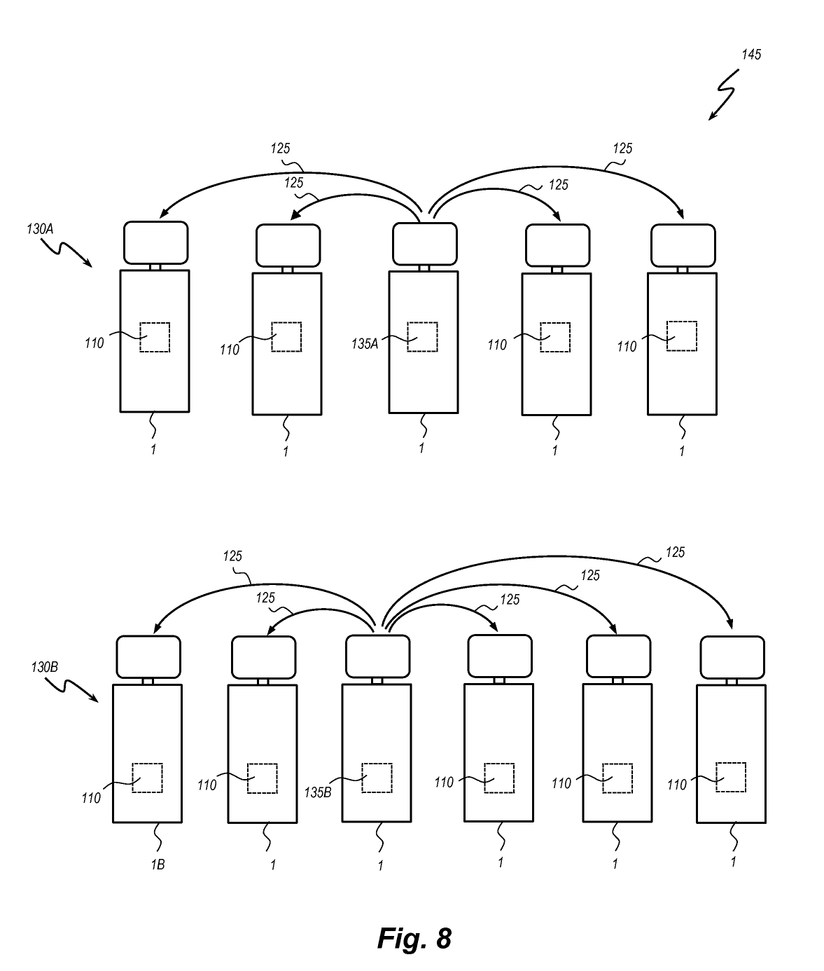

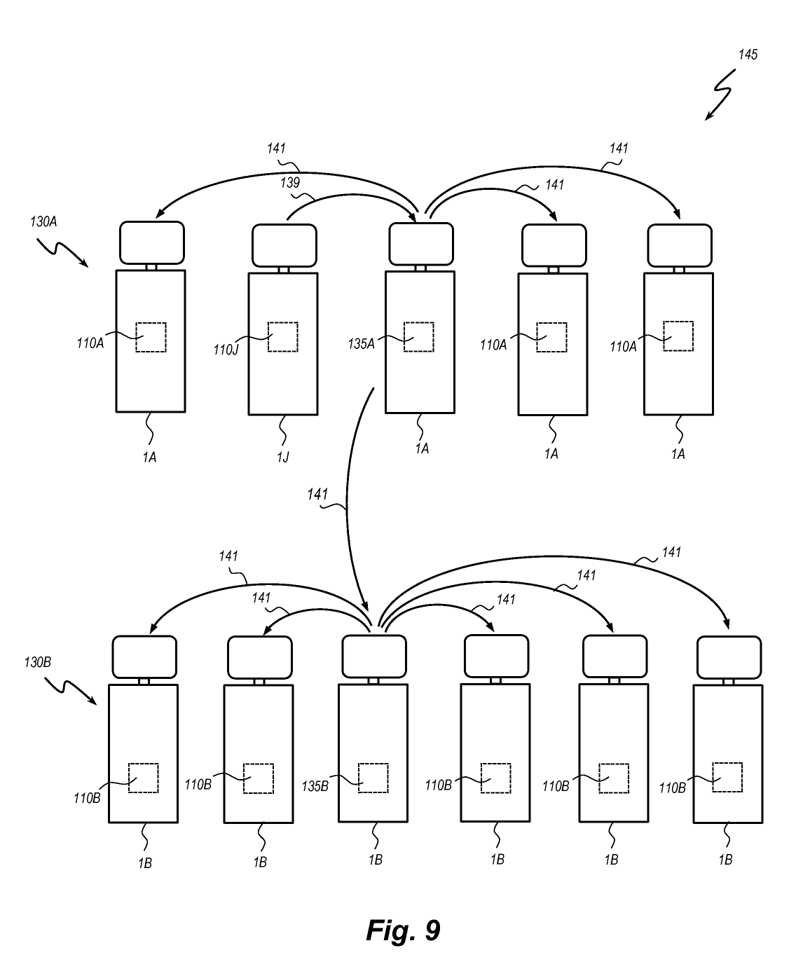

FIGS. 8 and 9 illustrate another embodiment of the invention where two separate groups 130A and 130B of electronic gaming machines 1 are connected within a network 145. One group 130A has five electronic gaming machines 1 while the other group 130B has six electronic gaming machines 1. The groups 130A and 130B may be physically separated from each other in the gaming venue, but form a common network 145 based on the same game theme or type of game mechanics. Within each group 130A and 130B, there is a master lighting controller 135A and 135B that controls the lighting controllers 110 of the other electronic gaming machines 1 in their respective groups, as best shown in FIG. 8. Where a game event as described above occurs on a played electronic gaming machine, such as electronic gaming machine 1J, the lighting controller 110J of the electronic gaming machine 1J transmits an RF signal 139 reporting the game event to the master lighting controller 135A in its group 130A, as best shown in FIG. 9. The master lighting controller 135A then transmits the RF signal 141 to the other lighting controllers 110A of the electronic gaming machines 1A in its group 130A. In addition, master lighting controller 135A also transmits the RF signal 141 to the master lighting controller 135B in the other group 130 B. The master lighting controller 135B receives and retransmits the RF signal 141 to the other lighting controllers 110B of the electronic gaming machines 1B in its group 130B. As a consequence, all of the electronic gaming machines 1A and 1B in groups 130A and 130B simultaneously display the same light presentation through their respective lighting systems 100 (and hence lighting devices 100A to 100G) as the light presentation displayed on the played electronic gaming machine 1J and associated with the game event. This further magnifies the uniform look and appearance of the electronic gaming machines 1 in the network 145, thus increasing their attraction to potential players.

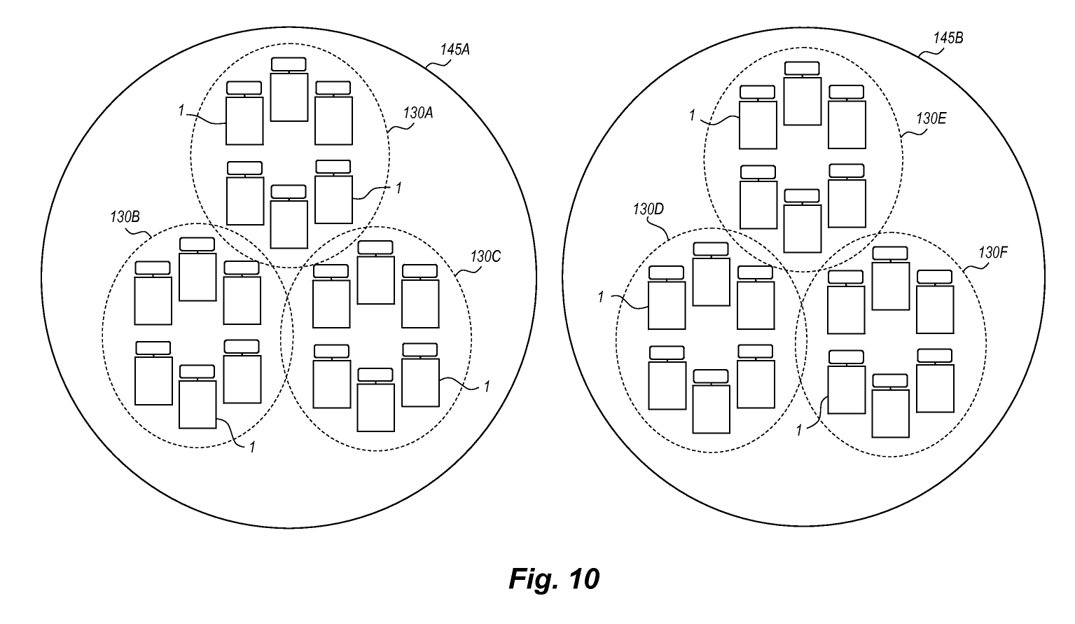

Referring to FIG. 10, another embodiment of the invention is illustrated, where there are two networks 145A and 145B, each having their own groups of electronic gaming machines 1. The network 145A has three groups 130A, 130B and 130C while the network 145B has three groups 130D, 130E and 130F. Each group 130A to 130F has the same number of electronic gaming machines 1, although it will be appreciated that the number of electronic gaming machines within a group (and hence in a network) may vary as required. Within each group there is a master lighting controller 135 controlling the other lighting controllers in its group. The electronic gaming machines 1 in groups 130A, 130B and 130C can communicate with each other via their respective lighting controllers with the network 145A. Likewise, the electronic gaming machines 1 in groups 130D, 130E and 130F can communicate with each other via their respective lighting controllers with the network 145B. However, there is no communication between electronic gaming machines across the networks 145A and 145B as the networks are separate to each other.

While the embodiments have been described with lighting controllers 110 and 135 transmitting and receiving RF signals 125, 137, 139 and 141, in a preferred application the RF signals are simply broadcast by the lighting controllers 110 and 135 on a specific wavelength so that only the lighting controllers 110 in a group 130 can interpret the RF signals and act in response to that RF signals. For example, the lighting controllers 110 will receive RF signals from other lighting controllers or the master lighting controller 135 and verify whether they meet the correct wavelength or contain a relevant code. Once verified, the lighting controller 110 will respond to the RF signal. Any other signals that are received by the lighting controllers 110 and 135, such as signals sent by other electronic gaming machines in the gaming venue, are processed but not verified and thus are not acted upon. In other embodiments, the signals are encrypted to ensure that the correct signals are received and processed by the lighting controllers 110 in the same group 130.

In further embodiments, each of the lighting controllers 110 comprise an audio controller that controls an audio system built into the electronic gaming machine 1 (typically formed in the cabinet 2 and/or the topper 90). In effect, the lighting controllers 110 (including the master lighting controller 135) become audiovisual controllers that control both the lighting system 100 and the audio system of their respective electronic gaming machines 1. Hence, in this case the master audiovisual controller 135 is able to control both the light presentation and audio presentation of the electronic gaming machines 1 through their respective audiovisual controllers 110. This results in the same audiovisual presentation (light and audio presentation) being shown simultaneously by electronic gaming machines 1 via the master audiovisual controller 135. This control also extends to where a game event occurs on one of the electronic gaming machines 1, so that the game event on one electronic gaming machine will trigger a change to the audiovisual presentations of the other electronic gaming machines 1 via the master audiovisual controller 135 in the same way as described in relation to the above embodiments. In other embodiments, instead of playing the same audio presentation on the other electronic gaming machines 1, the master audiovisual controller 135 transmits a signal to the other audiovisual controllers 110 so that the sound or audio of those electronic gaming machines 1 is reduced or muted to emphasise the audio presentation associated with the game event occurring on the played electronic gaming machine, while still showing the same light presentation.

In other embodiments, the lighting controllers 110 of the idle electronic gaming machines 1 each transmits a signal to their respective electronic game controllers 4 when receiving and processing the RF signal 141 from the master lighting controller 135. The electronic game controller 4 then transmits a signal to the display 7 so that the display of the game on the idle electronic gaming machines 1 changes in response to the game event displayed on the played electronic gaming machine. For example, such a change includes changing the reels displayed on the idle electronic gaming machines to show the same game symbols and game shown on the reels displayed on the played electronic gaming machine.

In some embodiments, the lighting controller 110 of one or more electronic gaming machines 1 (most preferably the lighting controller 110 of each electronic gaming machine 1) automatically detects when a master lighting controller 135 is enabled or disabled and operate accordingly. This may be done by the master lighting controller 135 transmitting or broadcasting an alert signal to advise when it is enabled or disabled that is received by the lighting controllers 110.

In other embodiments, venue personnel can have a handheld electronic device (such as a smart phone or RF equipped device) that can communicate with and identify the master lighting controller 135. This permits the master lighting controller 135 to be easily identified where there is a large group of electronic gaming machines 1. In further embodiments, any lighting controller 110 is individually identified by venue personnel using a handheld electronic device. In these embodiments, the master lighting controller 135 and other lighting controllers 110 have unique identifier codes that are sent in response to a query from the handheld device. Alternatively, the unique identifier codes are transmitted at regular intervals for reception by the handheld device. In addition, the electronic communication between the handheld device and the lighting controllers 110, 135 is encrypted for secure communication.

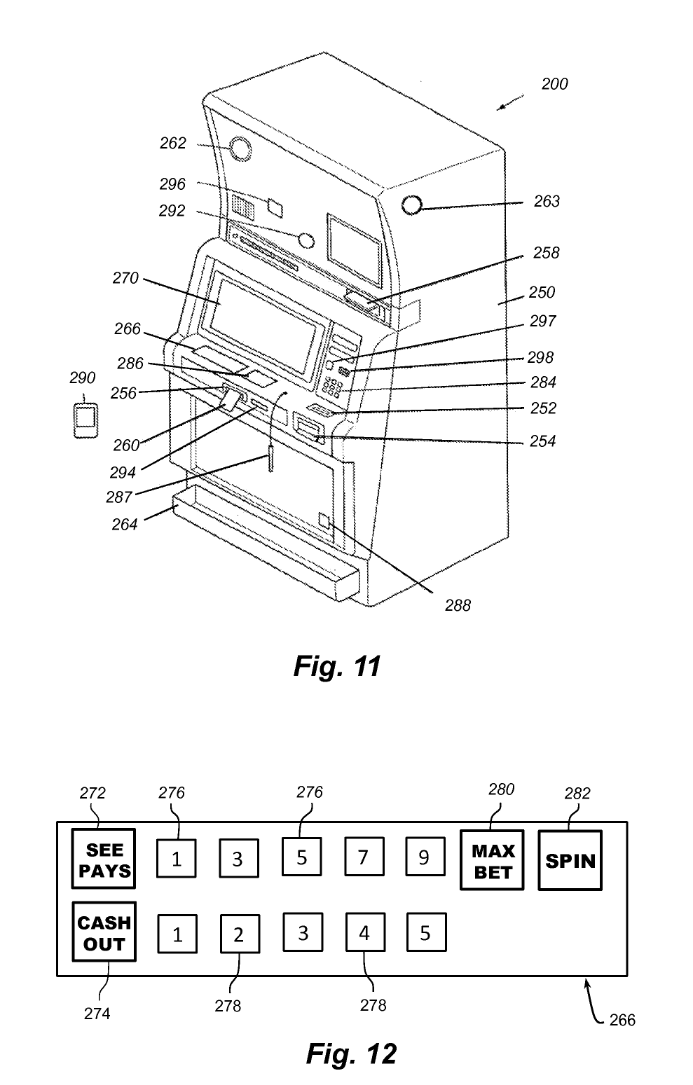

Referring to FIG. 11, another embodiment of the invention is shown in the form of an electronic gaming machine 200. The electronic gaming machine 200 may include a housing or cabinet 250 and one or more value transfer mechanisms or devices, which may include a coin slot or acceptor 252, a paper currency or bill acceptor 254, a ticket reader/printer 256 and a card reader 258, which may be used to input value to the electronic gaming machine 200. A value transfer device may include any device that can accept value from a player. The topper (not shown) may be mounted to the top of the electronic gaming machine 200.

If provided on the electronic gaming machine 200, the ticket reader/printer 256 may be used to read and/or print or otherwise encode ticket vouchers 260. The ticket vouchers 260 may be composed of paper or another printable or encodable material and may have one or more of the following informational items printed or encoded thereon: the casino name, the type of ticket voucher, a validation number, a bar code with control and/or security data, the date and time of issuance of the ticket voucher, redemption instructions and restrictions, a description of an award, and any other information that may be necessary or desirable. Different types of ticket vouchers 260 could be used, such as bonus ticket vouchers, cash-redemption ticket vouchers, casino chip ticket vouchers, extra game play ticket vouchers, merchandise ticket vouchers, restaurant ticket vouchers, show ticket vouchers, etc. The ticket vouchers 260 could be printed with an optically readable material such as ink, or data on the ticket vouchers 260 could be magnetically encoded. The ticket reader/printer 256 may be provided with the ability to both read and print ticket vouchers 260, or it may be provided with the ability to only read or only print or encode ticket vouchers 260. In the latter case, for example, some of the electronic gaming machines 200 may have ticket printers 256 that may be used to print ticket vouchers 260, which could then be used by a player in other electronic gaming machines 200 that have ticket readers 256.

If provided, the card reader 258 may include any type of card reading device, such as a magnetic card reader or an optical card reader, and may be used to read data from a card offered by a player, such as a credit card or a player tracking card. If provided for player tracking purposes, the card reader 258 may be used to read data from, and/or write data to, player tracking cards that are capable of storing data representing the identity of a player, the identity of a casino, the player's gaming habits, etc.

The electronic gaming machine 200 may include one or more audio speakers 262, a coin payout tray 264, an input control panel 266, and a colour video display unit 270 for displaying images relating to the game or games provided by the electronic gaming machine 200. The audio speakers 262 may generate audio representing sounds such as the noise of spinning reels, a dealer's voice, music, announcements or any other audio related to a game. The input control panel 266 may be provided with a plurality of pushbuttons or touch-sensitive areas that may be pressed by a player to select games, make wagers, make gaming decisions, etc.

FIG. 12 illustrates one possible embodiment of the control panel 266, which may be used where the electronic gaming machine 200 having a plurality of reels. The control panel 266 may include a “See Pays” button 272 that, when activated, causes the display unit 270 to generate one or more display screens showing the odds or payout information for the game or games provided by the electronic gaming machine 200. As used herein, the term “button” is intended to encompass any device that allows a player to make an input, such as an input device that must be depressed to make an input selection or a display area that a player may simply touch. The control panel 266 may include a “Cash Out” button 274 that may be activated when a player decides to terminate play on the electronic gaming machine 200, in which case the electronic gaming machine 200 may return value to the player, such as by returning a number of coins to the player via the payout tray 264.

The control panel 266 may be provided with a plurality of selection buttons 276, each of which allows the player to select a different number of pay lines prior to spinning the reels. For example, five buttons 276 may be provided, each of which may allow a player to select one, three, five, seven or nine pay lines.

The control panel 266 may also be provided with a plurality of selection buttons 78 each of which allows a player to specify a wager amount for each pay line selected. For example, the electronic gaming machine 200 may be provided with five selection buttons 78, each of which may allow a player to select 1¢, 2¢, 5¢, 10¢ and 20¢, to wager for each pay line selected. In that case, if a player were to activate one of the buttons 276 to select five pay lines and then activate one of the buttons 278 to select 5¢ per pay line to be wagered or bet, the total wager would be $0.25.

The control panel 266 may include a “Max Bet” button 280 to allow a player to make the maximum wager allowable for a game. In the above example, where up to nine pay lines were provided and up to 20¢ could be wagered for each pay line selected, the maximum wager would be $1.80 The control panel 266 may include a spin button 282 to allow the player to initiate spinning of the reels after a bet has been made.

In FIG. 12, a rectangle is shown around the buttons 272, 274, 276, 278, 280, 282. It should be understood that the rectangle simply designates, for ease of reference, an area in which the buttons 272, 274, 276, 278, 280, 282 may be located. Consequently, the term “control panel” should not be construed to imply that a panel or plate separate from the housing 250 of the electronic gaming machine 200 is required, and the term “control panel” may encompass a plurality or grouping of player activatable buttons.

Although one possible control panel 266 is described above, it should be understood that different buttons could be utilized in the control panel 266, and that the particular buttons used may depend on the game or games that could be played on the electronic gaming machine 200. Although the control panel 266 is shown to be separate from the display unit 270, it should be understood that the control panel 266 could be generated by the display unit 270. In that case, each of the buttons of the control panel 266 could be a coloured area generated by the display unit 270, and some type of mechanism may be associated with the display unit 270 to detect when each of the buttons was touched, such as a touch-sensitive screen.

As noted above, the electronic gaming machine 200 may include a mechanism by which the electronic gaming machine 200 may determine the identity of the player. In particular, the card reader 258 may be used to read a card that carries an identification code that may be uniquely associated with the player so that the gaming unit can differentiate that player from all other players, or so that the gaming unit can differentiate that player as a member of a group of players from all player not a member of the group of players. The electronic gaming machine 200 may also include equipment, such as a keypad 284, an input pad 286 (with optional stylus 287), a port (or antenna) 288 adapted to communicate via a wired or wireless link (infrared or radio frequency link, for example) to a mobile electronic device 290 (such as a personal digital assistant, smart phone or tablet), a camera 292, a scanner 294, a retinal (or iris) scanner 296, fingerprint scanner 297, and/or a microphone 298. The electronic gaming machine 200 may include any one of the devices 258, 284, 286, 288, 290, 292, 294, 296, 297, 298, or the electronic gaming machine 200 may include a combination of some or all of the devices 258, 284, 286, 287, 288, 290, 292, 294, 296, 297, 298.

In operation, a player may identify him or herself to the electronic gaming machine 200 by entering a unique numeric or alpha-numeric code using the key pad 284, for example. Alternatively, the player may use his or her finger or the stylus 287 to sign his or her signature on the input pad 286. As a further alternative, the player may sign his or her signature on the mobile electronic device 290, which signature is then converted to electronic data, and the data is then transferred via the port/antenna 288 to the electronic gaming machine 200. As yet another alternative, the player may sign his or her signature on a piece of paper that is then photographed using the camera 292 or scanned using the scanner 294 (or the bill acceptor 254) to convert the signature into electronic data. As an additional alternative, the player may place one of his or her fingers or his or her hand on the scanner 297, and the scanner 297 may generate an electronic data representation of the fingerprint on one or more of the player's fingers or an electronic data representation of the pattern of the entire hand. Alternatively, the camera 292 may be used to take a picture (live or still) of the player, the picture then being converted into electronic data. As a still further alternative, the player may place his or her eye up to the retinal (or iris) scanner 296, and the retinal (or iris) scanner 296 may generate an electronic data representation corresponding to the pattern of the retina (or iris) of the player. As yet another alternative, the player may speak into the microphone 298, and characteristics of the spoken words (or voiceprint) may be converted into an electronic data representation.

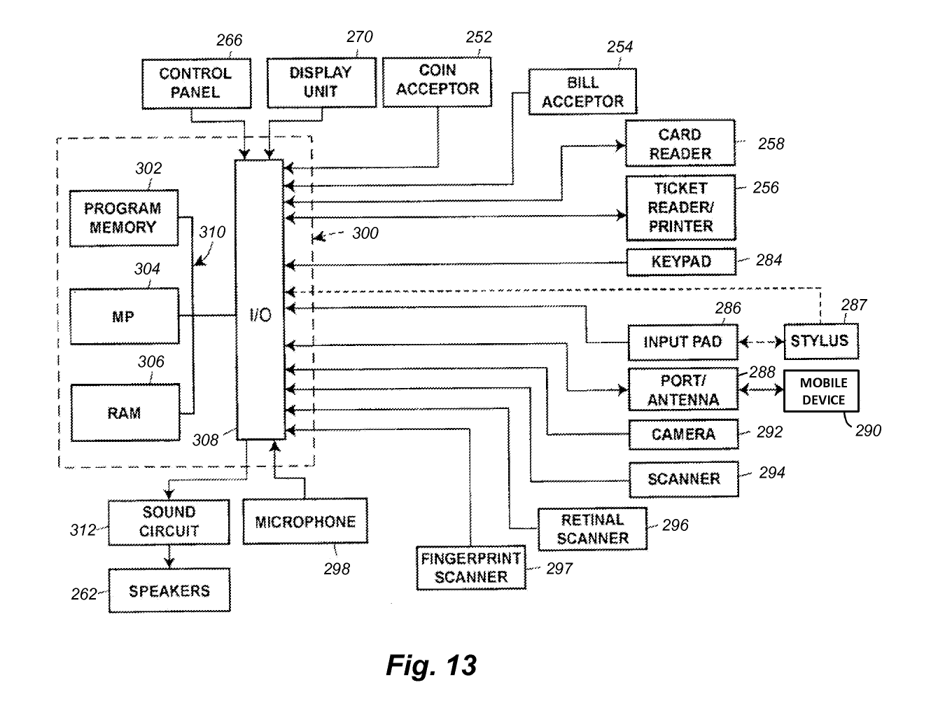

FIG. 13 is a block diagram of a number of components that may be incorporated in the electronic gaming machine 200. Referring to FIG. 13, the electronic gaming machine 200 may include a controller 300 that may comprise a program memory 302, a microcontroller or microprocessor (MP) 304, a random-access memory (RAM) 306 and an input/output (I/O) circuit 308, all of which may be interconnected via an address/data bus 310. It should be appreciated that although only one microprocessor 304 is shown, the controller 300 may include multiple microprocessors 304. Similarly, the memory of the controller 300 may include multiple RAMs 306 and multiple program memories 302. Although the I/O circuit 108 is shown as a single block, it should be appreciated that the I/O circuit 308 may include a number of different types of I/O circuits. The RAM(s) 304 and program memories 302 may be implemented as semiconductor memories, magnetically readable memories, and/or optically readable memories, for example.

FIG. 13 illustrates that the coin acceptor 252, the bill acceptor 254, the ticket reader/printer 256, the card reader 258, the control panel 266, the display unit 270, the keypad 284, the input pad 286 (and optionally the stylus 287), the port/antenna 288, the digital camera 292, the scanner 294, the retinal scanner 296, the fingerprint scanner 297 and the microphone 298 may be operatively coupled to the I/O circuit 308, each of those components being so coupled by either a unidirectional or bidirectional, single-line or multiple-line data link, which may depend on the design of the component that is used. The speaker(s) 262 may be operatively coupled to a sound circuit 312, that may comprise a voice- and sound-synthesis circuit or that may comprise a driver circuit. The sound-generating circuit 312 may be coupled to the I/O circuit 308.

As shown in FIG. 13, the components 252, 254, 256, 258, 266, 270, 284, 286, 287, 288, 292, 294, 296, 297, 298, 312 may be connected to the I/O circuit 308 via a respective direct line or conductor. Different connection schemes could be used. For example, one or more of the components shown in FIG. 12 may be connected to the I/O circuit 308 via a common bus or other data link that is shared by a number of components. Furthermore, some of the components may be directly connected to the microprocessor 304 without passing through the I/O circuit 308.

It will be appreciated that while the preferred embodiments have been described in relation to an industry standard electronic gaming machine, the invention can be readily applied to other types of electronic gaming machines, including a personal computer (standing alone or connected to a communications network, LAN or WAN, WLAN), mobile electronic devices (such as handheld or portable electronic devices like tablets and smart phones) and other electronic devices capable of displaying a game. In the case of mobile electronic devices, in one arrangement the mobile electronic device may permit the player to make bets using “virtual” credits that represent a monetary value, but do not require the player to make a monetary transaction. Instead, the invention may provide a tiered access to the various features of the game so that the player can make relatively small payments to access particular features of the game or obtain additional benefits during game play. An alternative arrangement would require the player to purchase virtual credits or tokens via an interface on the mobile electronic device or an online interface accessible by the mobile electronic device. A further arrangement would not require any monetary transaction at all. Similarly, the above described arrangements can be applied where the invention is implemented on a personal computer (PC) connected to the internet (wirelessly or not). In one example of the implementation, the PC would access an online casino over the internet to play the game of the invention or the game of the invention would be part of a social networking website. It is also contemplated that the player could also make regular payments to subscribe to continue playing the game on the mobile electronic device, PC or other electronic device.

In an alternative embodiment, the electronic gaming machine also provides an option for the player to play with either credits based on a monetary amount or virtual credits as discussed above. This can be implemented by way of a selection menu prior to playing the selected game or by providing a suitable menu button on screen during play of the selected game.

In another aspect, the invention includes a computer programme configured to perform the invention. In this way the invention can be implemented in various ways on an electronic gaming machine. In a further aspect, the invention includes a gaming system configured comprising a central processing unit (such as a computer or computational processor) configured for communication with an electronic gaming machine to perform the invention. In a yet another aspect, the invention includes a non-transitory carrier medium carrying computer executable code that, when executed on a central processing unit configured for communication with an electronic gaming machine, causes said central processing unit to perform the invention. In this case, the non-transitory carrier medium includes an external hard drive, a memory device, including a memory card, smart card, a radio frequency identification (RFID) device, USB key, magnetic card or other electronic storage device.

It will further be appreciated that any of the features in the preferred embodiments of the invention can be combined together and are not necessarily applied in isolation from each other. For example, the electronic gaming machine of FIG. 1 may be used instead of the electronic gaming machine of FIG. 3 in the groups 130 and/or networks 145. Similar combinations of two or more features from the above described embodiments or preferred forms of the invention can be readily made by one skilled in the art.

By providing a system and method for synchronising the light presentation by a group of electronic gaming machines, there is created an overall uniform visual look to the electronic gaming machines that attracts potential players. In addition, where a game event occurs on one electronic gaming machine, all the electronic gaming machines in the group display the same light presentation associated with the game event, thus making the electronic gaming machines more prominent and attractive to potential players amidst the other gaming machines displaying their individual light presentations in the gaming venue. Where the game event is a winning game event, the display of the associated light presentation by all the electronic gaming machines in the group makes each electronic gaming machine more attractive to potential players, and hence increases the interest of potential players in playing one of the electronic gaming machines. All these advantages of the invention result in increasing the attraction of the electronic gaming machines in the group and thus making is more likely that players will play the electronic gaming machines. Furthermore, since the lighting controller controls operation of the lighting devices for the electronic gaming machine, the invention can be readily implemented to existing gaming machines and other gaming systems. In all these respects, the invention represents a practical and commercially significant improvement over the prior art.

Although the invention has been described with reference to specific examples, it will be appreciated by those skilled in the art that the invention may be embodied in many other forms.

1. A system for synchronising a plurality of electronic gaming machines, comprising:
a plurality of electronic gaming machines in electronic communication with each other, each said electronic gaming machine comprising:
a display for displaying a game;
an electronic game controller in electronic communication with said display for controlling the display of game symbols on the display;
a lighting device for displaying a light presentation on said electronic gaming machine; and
a lighting controller in electronic communication with said lighting device for controlling the display of said light presentation by said lighting device;
wherein said lighting controllers of said electronic gaming machines are in electronic communication with each other;
one of said lighting controllers is designated as a master lighting controller for controlling the other lighting controllers; and
said master lighting controller transmits one or more signals to said lighting controllers so that said lighting devices of said electronic gaming machines are synchronised to display the same light presentation simultaneously.

2. The system of claim 1, wherein, in response to a game event on a first electronic gaming machine, said lighting controller of said first electronic gaming machine transmits a first signal to said master lighting controller reporting said game event and said master lighting controller transmits a second signal to each of said lighting controllers to change the light presentation displayed by said lighting device on each of said electronic gaming machines simultaneously to another light presentation.

3. The system of claim 2, wherein said lighting controller of said first electronic gaming machine broadcasts said first signal to each of said lighting controllers.

4. The system of claim 1, wherein said lighting controllers are in wireless electronic communication with each other.

5. The system of claim 1, wherein each said lighting controller comprises a transmitter for transmitting signals and a receiver for receiving signals.

6. The system of claim 5, wherein each said lighting controller comprises a transceiver for transmitting and receiving signals.

7. The system of claim 6, wherein said transceiver comprises a radio frequency module.

8. The system of claim 1, wherein, where the designation of said one of lighter controllers as said master lighting controller is removed, another of said lighting controllers is designated as said master lighting controller.

9. The system of claim 1, wherein, in response to said master lighting controller being deactivated, another of said lighting controllers is designated as said master lighting controller.

10. The system of claim 1, wherein each said electronic gaming machine comprises a housing having said display and a body portion, and wherein said lighting device is arranged on said body portion.

11. The system of claim 1, wherein each said electronic gaming machine comprises a housing having said display and a removable head portion, and wherein said lighting device is arranged on said removable head portion.

12. The system of claim 1, wherein each said electronic gaming machine comprises a housing having said display and a foot portion, and wherein said lighting device is arranged on said foot portion.

13. The system of claim 1, wherein each said electronic gaming machine comprises an input device for receiving commands from a player to operate said electronic gaming machine and initiate play of said game on said display, said input device being in electronic communication with said electronic game controller and wherein said lighting device is arranged adjacent to said input device.

14. The system of claim 1, wherein each said electronic gaming machine comprises a housing having said display and a value transfer mechanism for paying said prizes to said player using value in an amount equal to an awarded prize, and wherein said lighting device is arranged adjacent to value transfer mechanism.

15. The system of claim 1, wherein said lighting device comprises one or more light emitting diodes.

16. The system of claim 1, wherein said lighting controller controls a lighting system, said lighting system comprising a plurality of said lighting devices.

17. The system of claim 1, wherein said game event comprises a prize award event that results in the award of a prize on said first electronic gaming machine.

18. The system of claim 17, wherein said prize award event comprises one or more of a winning combination of game symbols resulting in the award of said prize, the appearance of a symbol that awards a prize, winning a bonus prize and winning a jackpot prize.

19. The system of claim 1, wherein said game event comprises a game enhancing event that enhances said game on said first electronic gaming machine.

20. The system of claim 19, wherein said game enhancing event comprises an event that enhances the game play of said game or confers a game enhancing element upon said player in said game.

21. The system of claim 20, wherein said game enhancing event comprises one or more of triggering a feature game, additional free plays or spins of said game, the appearance of symbols that increase the amount of any awarded prizes and the appearance of symbols that increase the probability of a winning combination of symbols appearing in said game.
